(19) United States
(12) Patent Application Publication
(10) Pub. No.: US 2016/0065826 A1
(43) Pub. Date: Mar. 3, 2016

(54) Device and Method for Photographic Synchronization

(71) Applicant: Harvest One Limited, Hong Kong (HK)

(72) Inventors: Wing Hang Henry CHAN, Hong Kong (HK); Man Chung HO, Hong Kong (HK); Wai Kwan LING, Hong Kong (HK)

(21) Appl. No.: 14/475,590

(22) Filed: Sep. 3, 2014

(51) Int. Cl. H04N 5/232; H04N 5/225

(52) U.S. Cl. CPC H04N 5/23206; H04N 5/2256; H04N 5/2258

(57) ABSTRACT

The invention provides a method and a device for synchronizing a flash unit with a camera. The method comprises steps of communicating a first encoded signal from the camera to a trigger; decoding the first encoded signal by the trigger to form a first decoded data; encoding the first decoded data to form a second encoded signal, and communicating the second encoded signal to the flash; wherein the first and the second encoded signals are of different system-specific formats. The device comprises an input for communicating a first encoded signal with the camera; a first decoder for decoding the first encoded signal to form a first decoded data; a first encoder for encoding the first decoded data to form a second encoded signal; and an output for communicating the second encoded signal with the flash; wherein the first and the second encoded signals are of different system-specific formats.

### FIELD OF THE INVENTION

The invention relates to a device and a method for synchronizing a plurality of photographic devices. Particularly but not exclusively, the invention relates to a triggering device for synchronizing the operation of multiple flash units with a camera during image acquisition and the method thereof.

### BACKGROUND OF THE INVENTION

Various photographic triggering systems have been developed to assist communication between a camera and their corresponding flash units for a synchronized operation during image acquisition, especially during outdoor shootings when effective synchronization among multiple remote flashes and the camera is critical.

A number of new developments have been applied to improve the triggering devices in the market. For example, the Through-The-Lens (TTL) flash metering technology has been applied to photographic triggering systems to provide automation in lighting control such as exposure adjustment. A number of wireless technologies such as Infrared (IR), cellular, light pulse, and radio frequency (RF) have also been adopted for remotely synchronizing multiple photographic devices during image acquisition. Nevertheless, there are still limitations on the existing triggering systems in terms of adaptability, convenience of use and price.

### OBJECTS OF THE INVENTION

An object of the present invention is to provide a triggering device for synchronizing operations of multiple photographic devices, in which the aforesaid shortcomings are mitigated or at least to provide a useful alternative.

The above object is met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

in a first main aspect, the invention provides a method for synchronizing at least one lighting unit with a photographic apparatus for image acquisition. The method comprises the steps of communicating a first encoded signal from the photographic apparatus to a triggering device; decoding the first encoded signal by the triggering device to form a first decoded data; encoding the first decoded data to form a second encoded signal; and communicating the second encoded signal to the at least one lighting unit; wherein the first encoded signal is of a first system-specific format and the second encoded signal is of a second, different system-specific format.

In a second main aspect, the invention provides a device for synchronizing at least one lighting unit with a photographic apparatus for image acquisition. The device comprises an input for communicating a first encoded signal with a photographic apparatus; a first decoder for decoding the first encoded signal to form a first decoded data; a first encoder for encoding the first decoded data to form a second encoded signal; and an output for communicating the second encoded signal with at least one lighting unit; wherein the first encoded signal is of a first system-specific format and the second encoded signal is of a second, different system-specific format.

In a third main aspect, the invention provides a system for use in image acquisition. The system comprises a device as described in the second main aspect, and at least one of a lighting unit and a photographic apparatus.

In a fourth main aspect, the invention provides a computer readable medium carrying machine readable instructions which, when executed by a processor of a device for synchronizing at least one lighting unit with a photographic apparatus for image acquisition implements the steps of the method as mentioned in the first main aspect above. The invention is advantageous in that it provides a triggering device which enables synchronized use between a camera and a flash unit which are of different system formats, or a camera and multiple flash units which are of different system formats, and optionally, in a wireless manner. This allows a versatile, convenient use of camera and lighting units in a cross-makes, cross-brands or cross-manufacturers manner. In contrast, the exiting products in the market allow synchronization only when the camera and the flash unit(s) are of the same system format, i.e. devices which are manufactured by exclusive manufacturers, which leads to a very limited choice of devices for the users and typically higher costs. The present invention is beneficial in offering improved flexibility, adaptability and variability among devices from various brands and manufacturers, which significantly broadens the selections of triggers available to users and reduces costs.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a block diagram showing a device as embodied in the present invention;

FIG. 2 is a block diagram showing the hardware architecture of the embodiment of FIG. 1;

FIG. 3 is a block diagram showing the software programming of the embodiment of FIG. 1; and

FIG. 4 is a block diagram showing the wireless communication of the embodiment of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In the context of this specification, the term “synchronize”. “synchronizing” or “synchronization” refers to the simultaneous operation of a plurality of photographic devices such as, but not limited to, flash units and cameras, and that the operation may include the action of triggering and/or transmitting of information among the plurality of photographic devices.

In addition, a person skilled in the art would appreciate that the expression of “lighting unit” as referred to in the present invention should not be limited to photographic flash light of any specific configuration, but to lighting of any constructions as long as it is considered suitable in this field for this particular purpose. Similarly, the expression of “photographic apparatus” or “photographic device” should not be limited to a photographic camera only, but should be given a broad meaning to refer to any device, equipment or module which relates to the generation of images including static images (i.e. photography) and moving images (i.e. videography). The “photographic apparatus” or “photographic device” as embodied in the present invention may therefore encompasses photographic cameras, video cameras, and any parts or units which work with the cameras such as lighting units, as long as they are considered applicable by a person skilled in the art.

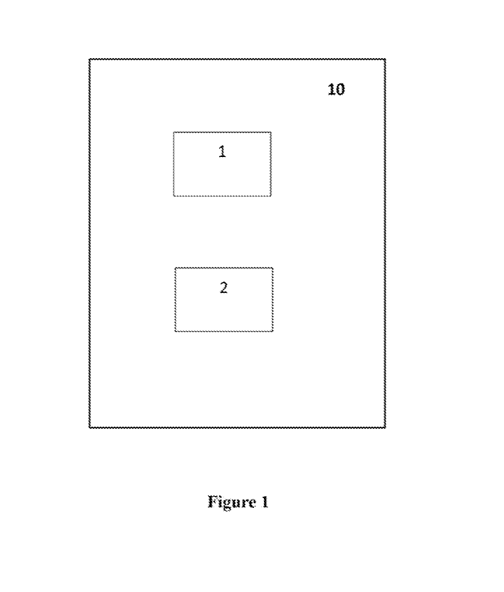

An embodiment of the present invention is illustrated in the block diagrams of FIGS. 1-4, in which a triggering device for synchronizing at least one lighting unit such as a flash light with a photographic apparatus such as a camera, and the method thereof, are shown.

Particularly, the method comprises steps of communicating a first encoded signal from the camera to the triggering device; decoding the first encoded signal by the triggering device to form a first decoded data; encoding the first decoded data to form a second encoded signal; and communicating the second encoded signal to the at least one lighting unit; wherein the first encoded signal is of a first system-specific format and the second encoded signal is of a second, different system-specific format.

More particularly, the device comprises a computer readable medium carrying machine readable instructions which, when executed by a processor of the device, implements the steps of the method as mentioned above.

The device further comprises an input for receiving a first encoded signal from the camera; a first decoder for decoding the first encoded signal to form a first decoded data; a first encoder for encoding the first decoded data to form a second encoded signal; and an output for transmitting the second encoded signal to at least one lighting unit; wherein the first encoded signal is of a first system-specific format and the second encoded signal is of a second, different system-specific format.

Referring to FIG. 1, a triggering device 10 as embodied in the present invention is illustrated. The triggering device 10 includes at least a computer readable medium 1 such as a memory storage unit, which carries system instructions readable by the device 10, and the lighting unit and the camera when connected therewith. The system instructions, when executed by a processor 2 such as micro control unit (MCU) of the device 10, implements synchronization between the lighting unit and the camera.

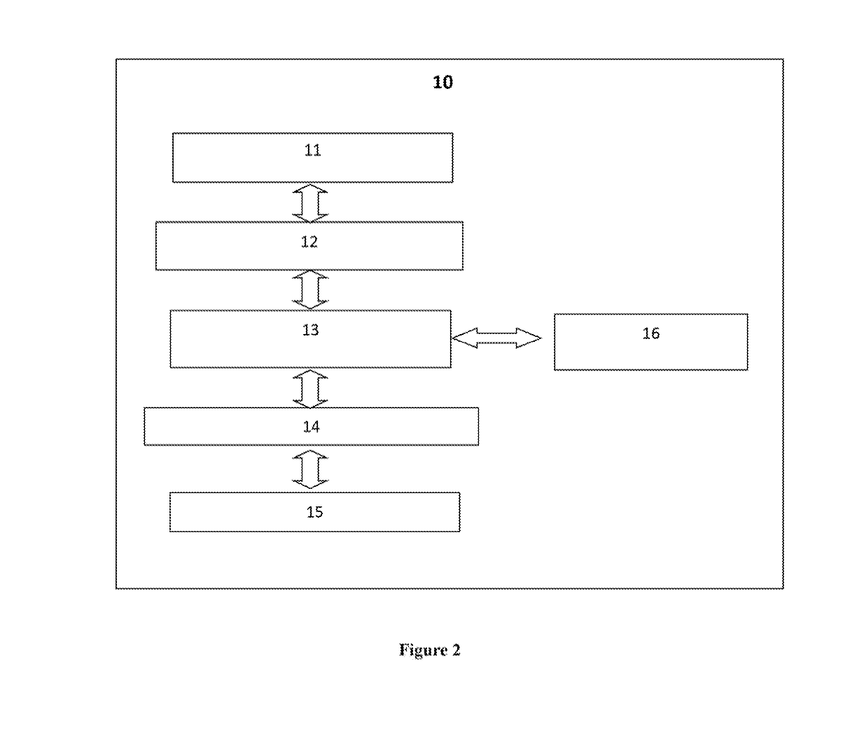

Referring to FIGS. 2-4, details of the hardware architecture, software program and wireless communication diagrams of the triggering device 10 are shown. In this embodiment, the triggering device 10 is designed for use in a Though-The-Lens (TTL) camera system. However, a person skilled in the art should appreciate that the application of the current invention should not be limited to photographic devices of any particular configurations, functions or applications.

In this embodiment, the triggering device 10 is connected with a flash unit 21 and a camera 27 via hotshoe connectors 11 and 15, respectively. The flash hotshoe connector 11 and the camera hotshoe connector 15 are adapted to connect the device 10 with flash unit 21 and the camera 27 of different system formats, i.e. the flash unit 21 and the camera 27 can be of different makes, brands or manufacturers. Specifically, the hotshoe connector 15 is adapted to receive an encoded signal 15a from the camera 27, and that the hotshoe connector 11 is adapted to transmit another encoded signal 11a from the device 10 to the flash unit 21.

The encoded signal 15a as received by the camera hotshoe connector 15 is first processed by a camera signal level shifting circuit 14. The level shifted signal 14a from the circuit 14 will then be transmitted to a micro control processing unit (MCU) 13 for digital signal processing. Specifically, the MCU 13 includes a TTL frame decoder 24 for decoding the encoded, level shifted signal 14a. The decoded signal 24a comprises setting information of the camera system 27 such as aperture, exposure value, focal length or ISO. The MCU 13 stores these parameters in a memory location 23 and then passes them to a TTL frame encoder 22. The TTL frame encoder 22 encodes the decoded signal of the system parameters into a flash system-specific format, so as to enable flash unit of any camera systems to recognize the corresponding system-specific signal. The flash unit 21 can therefore be of any makes, brands or manufacturers such as Canon, Nikon, Pentax, Sony etc. or even of a generic type, and would be operable with cameras of the same or different brands or manufactures when they are connected with the triggering device 10. This is advantageous as the choice of flash units available to the user can no longer be limited to the exclusive brand or manufacture of the camera, which allows greater flexibility, convenience of use and possibly reduction of costs.

The flash format-specific encoded signal 22a will then level shifted by a flash signal level shifting circuit 12, which will be transmitted via the flash hotshoe connector 11 to the flash unit 21.

A reverse but similar process is followed for signal feedback from the flash unit 21 to the camera 27, which may include transmitting an encoded flash signal from the flash unit 21 via the flash hotshoe connector 11 and subsequently the flash signal level shifting circuit 12 to the device 10; decoding the encoded flash signal by a TTL frame decoder (not shown) of the MCU 13; storing of the decoded parameters of setting information in the memory location 23 of the MCU 13; encoding the decoded signal by a TTL frame encoder (not shown) of the MCU 13; level shifting the encoded signal; and transmitting the encoded camera signal to the camera 27 in a camera-specific system format via the camera hotshoe connector 15.

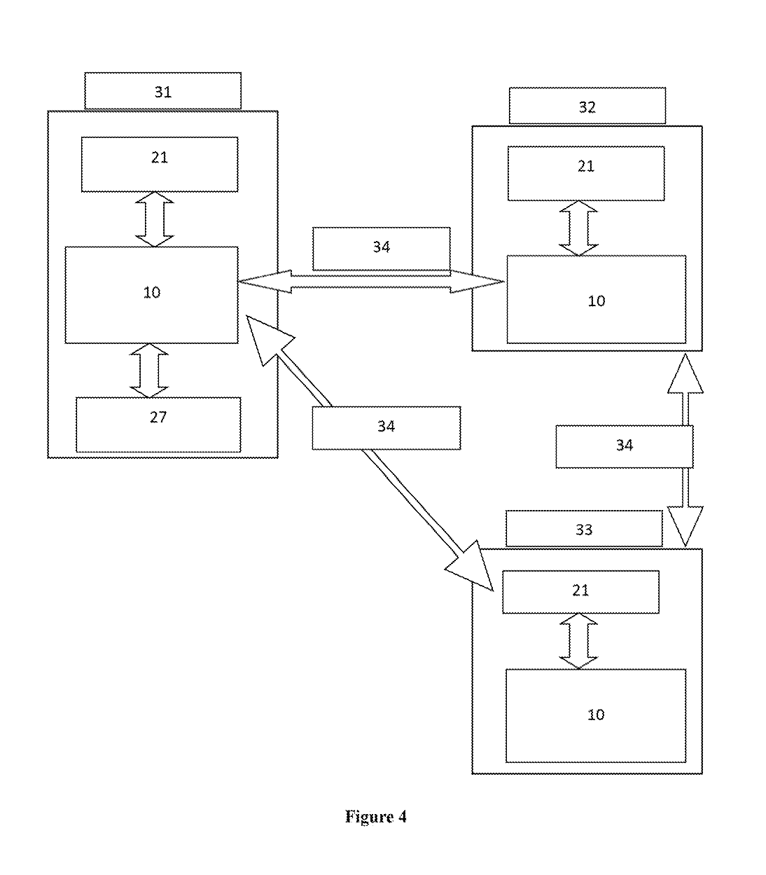

Multiple triggering devices 10 can be used to achieve wireless communication of signals within a system of camera with multiple, remote flash units. As shown in FIG. 4, multiple triggering devices 10A, 10B and 10C are arranged to operate in a “master” and “slave” relationship. In this embodiment, the master system 31 includes a camera 27A connected with a flash unit 21A via a triggering device 10A, and the two slave systems 32 and 33 each includes a flash unit 21B, 21C connected with the corresponding triggering device 10B and 10C, respectively. Each of the triggering devices 10A, 10B and 10C further comprises a radio frequency (RF) unit 16A, 16B, 16C (not shown) such as a RF transceiver, a RF transmitter or a RF receiver to allow communication of radio signals 34 wirelessly among the master system 31 and the slave systems 32 and 33. Specifically, the RF units are controlled by the MCUs 13 of the respective triggering devices 10 by permitting conversion between digital signals and analog radio frequency, so that the triggering devices 10 are adapted to communicate wirelessly with one another within the system.

In one embodiment, for wireless signal processing, the MCU 13 of the triggering device 10A of the master system 31 is adapted to encode the camera settings stored in the memory location 23 by using a RF frame encoder 25, and the encoded settings will be transmitted to at least one of the triggering devices 10B, 10C of the slave systems 32, 33 through radio frequency transmitted by the radio frequency transceivers 16A, 16B, 16C. The radio frequency transceivers 16B, 16C of the slave systems 32, 33 will receive the radio signal 34 from the radio frequency transceiver 16A of the master system 31, and the signal 34 will then pass to a RF frame decoder 26 to decode the signal 34 to form a decoded signal of camera parameters. Subsequently, the camera parameters will be stored in the memory location 23 for digital signal processing. Specifically, the decoded camera parameters will be sent to the TTL frame encoder 22 for encoding into a flash system-specific format, so that any flash unit of the particular slave system would be able to recognize the corresponding system-specific signals from the master system 31 and/or another slave system. The encoded signal can be transmitted to the flash unit by, for example, the flash hotshoe connector 11 after signal level shifting by the flash signal level shifting circuit 12.

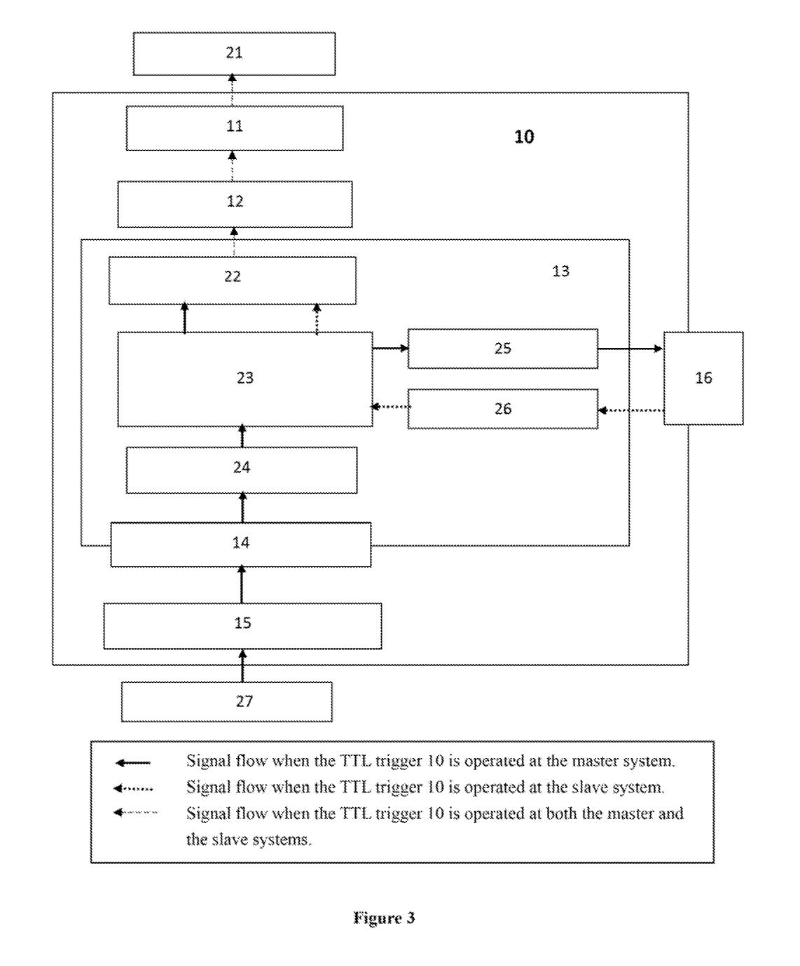

Although each of the master system 31 and the two slave systems 32 and 33 as shown in FIG. 3 are connected with a triggering device 10, in reality each of the master system and the slave systems may consist of more than one triggering device and form any different combinations. In addition, the direction of wireless communication can also be unilateral or bilateral, i.e. Master to Slave, Master to Master, or Slave to Slave etc. Furthermore, the slave system can be configured in any combinations such as trigger+flash, flash+trigger+camera, camera+trigger, or trigger alone. The master system can also be of any combinations such as trigger+flash, flash+trigger+camera, camera+trigger, or trigger alone.

Although the use of radio frequency as a means of wireless transmission is exemplified in this specific embodiment, a person skilled in the art would appreciate that other types of wireless technologies known such as infrared (IR), cellular, light pulse, Bluetooth™ or wifi may also be applicable, as long as the application of such wireless technologies will be considered suitable and reasonable in the field.

The present invention is therefore advantageous in that it provides a wireless triggering device which enables a synchronized use between a camera and a flash unit which are of different system formats, or a camera and multiple flash units which are of different system formats. In contrast to the existing products in the market which allow synchronization between camera and flashes only when the camera and the flash units are of the same system format, the present invention enables a convenient use of camera and flash units in a versatile cross-makes, cross-brands or cross-manufacturers manner. Accordingly, the present invention overcomes the restriction of the prior art, significantly broadens the selection of flashes and cameras available to the users, and assists in avoiding the potential high costs due to the exclusive use of flashes or cameras of certain brands.

1. A method for synchronizing at least one lighting unit with a photographic apparatus for image acquisition, the method comprising steps of:
communicating a first encoded signal from the photographic apparatus to a triggering device;
decoding the first encoded signal by the triggering device to form a first decoded data;
encoding the first decoded data to form a second encoded signal; and
communicating the second encoded signal to the at least one lighting unit;
wherein the first encoded signal is of a first system-specific format and the second encoded signal is of a second, different system-specific format.

2. The method according to claim 1, further comprising steps of:
communicating a third encoded signal from the at least one lighting unit to the triggering device;
decoding the third encoded signal by the triggering device to form a second decoded data; encoding the second decoded data to form a fourth encoded signal; and
communicating the fourth encoded signal to the photographic apparatus;
wherein the third encoded signal is of a third system-specific format and the fourth encoded signal is of a fourth, different system-specific format.

3. The method according to claim 1, wherein at least one of the communicating steps is conducted via a hotshoe connector.

4. The method according to claim 1, wherein at least one of the communicating steps is conducted in a wireless manner.

5. The method according to claim 1, wherein the decoding step is conducted by a through-the-lens decoder.

6. The method according to claim 1, wherein the encoding step is conducted by a through-the-lens encoder.

7. The method according to claim 1, wherein the decoding step is conducted by a radio frequency encoder.

8. The method according to claim 1, wherein the encoding step is conducted by a radio frequency encoder.

9. A device for synchronizing at least one lighting unit with a photographic apparatus for image acquisition, the device comprising:
an input for communicating a first encoded signal with a photographic apparatus;
a first decoder for decoding the first encoded signal to form a first decoded data;
a first encoder for encoding the first decoded data to form a second encoded signal; and
an output for communicating the second encoded signal with at least one lighting unit;
wherein the first encoded signal is of a first system-specific format and the second encoded signal is of a second, different system-specific format.

10. The device according to claim 9, further comprising:
a second decoder for decoding a third encoded signal to form a second decoded data;
a second encoder for encoding the second decoded data to form a fourth encoded signal;
wherein the third encoded signal is adapted to be communicated between the at least one lighting unit and the device via the output, and that the fourth encoded signal is adapted to be communicated between the device and the photographic apparatus via the input;
wherein the third encoded signal is of a third system-specific format and the fourth encoded signal is of a fourth, different system-specific format.

11. The device according to claim 9, wherein at least one of the input and the output comprises a hotshoe connector.

12. The device according to claim 9, wherein at least one of the input and the output is selected from a group consisting of a radio frequency transmitter, a radio frequency receiver and a radio frequency transceiver.

13. The device according to claim 9, wherein the first encoder comprises at least one of a through-the-lens encoder and a radio frequency encoder.

14. The device according to claim 10, wherein the second encoder comprises at least one of a through-the-lens encoder and a radio frequency encoder.

15. The device according to claim 9, wherein the first decoder comprises at least one of a through-the-lens decoder and a radio frequency decoder.

16. The device according to claim 10, wherein the second decoder comprises at least one of a through-the-lens decoder and a radio frequency decoder.

17. The device according to claim 9, further comprising a memory unit for storing at least one of the first and the second decoded data.

18. The device according to claim 9, wherein the first decoded data comprises at least one image acquisition setting.

19. The device according to claim 10, wherein the second decoded data comprises at least one image acquisition setting.

20. A system for use in image acquisition, comprising a device according to claim 9 and at least one of a lighting unit and a photographic apparatus.

21. A computer readable medium carrying machine readable instructions which, when executed by a processor of a device for synchronizing at least one lighting unit with a photographic apparatus for image acquisition implements the steps of the method according to claim 1.
